(19) United States
(12) Patent Application Publication
(10) Pub. No.: US 2025/0043192 A1
(43) Pub. Date: Feb. 6, 2025

(54) METHOD FOR PRODUCING SUSTAINABLE AVIATION FUEL

(71) Applicant: NATIONAL CHENG KUNG UNIVERSITY, Tainan City (TW)

(72) Inventor: Wei-Cheng WANG, Tainan City (TW)

(21) Appl. No.: 18/486,371

(22) Filed: Oct. 13, 2023

(30) Foreign Application Priority Data
Jul. 31, 2023 (TW) 112128662

(51) Int. Cl. C10G 3/00; B01J 23/755; B01J 29/85; B01J 37/02; C10G 45/64; C10G 47/20

(52) U.S. Cl. CPC C10G 3/50; B01J 23/755; B01J 29/85; B01J 37/0201; C10G 3/45; C10G 45/64; C10G 47/20; C10G 2300/1014; C10G 2300/307; C10G 2300/4006; C10G 2300/70; C10G 2400/08

(57) ABSTRACT

A method for producing a sustainable aviation fuel includes (a) subjecting a feedstock containing an oil to a first reaction with hydrogen in the presence of a first catalyst so that the oil is hydrogenated to saturation and deoxygenated, thereby obtaining a first product containing hydrocarbons, the first reaction being carried out at a temperature ranging from 385° C. to 415° C.; and (b) subjecting the first product to a second reaction with hydrogen in the presence of a second catalyst so that the hydrocarbons in the first product are cracked and isomerized, thereby obtaining the sustainable aviation fuel, the second catalyst including a silicoaluminophosphate-11 (SAPO-11) carrier loaded with nickel and citric acid, the nickel being present in an amount ranging from 12 wt % to 30 wt % based on 100 wt % of the second catalyst.

### CROSS-REFERENCE TO RELATED APPLICATION

This application claims priority to Taiwanese Invention Patent Application No. 112128662, filed on Jul. 31, 2023, which is incorporated by reference herein in its entirety.

### FIELD

The disclosure relates to a method for manufacturing a sustainable aviation fuel.

### BACKGROUND

With the flourishing of the aviation industry, emissions of carbon dioxide and particulate pollutants generated due to burning of petroleum in aircraft engines are increasingly greater every year. This phenomenon not only exacerbates damage to the atmospheric condition but also causes an adverse impact on climate change. Therefore, it is urgent to develop an alternative fuel that has a similar structure and properties to a hydrocarbon composition of a conventional petroleum-based aviation fuel. For the aviation industry, among all of the alternative fuels currently developed, sustainable aviation fuel (SAF) has the greatest potential for mitigating climate change and is recognized by the public as a clean fuel since such sustainable aviation fuel contains almost no sulfide and produces fewer particulate pollutants after being burned. As long as the sustainable aviation fuel is properly blended with the petroleum-based aviation fuel in compliance with the aviation fuel specifications, it may become a new fuel for aircraft engines.

To be more specific, the hydrocarbon composition of the petroleum-based aviation fuel that meets the requirements of the aviation fuel specifications may include, from the viewpoint of carbon number, hydrocarbons with different carbon numbers where C8 to C14 hydrocarbons have the highest content share, or may include, from the viewpoint of molecular structure, linear hydrocarbons and non-linear hydrocarbons where a ratio of the non-linear hydrocarbons (i.e., iso-alkanes) to the linear hydrocarbons (i.e., normal alkanes) in decimal form (hereinafter abbreviated as “I/N ratio”) falls within a range from 2 to 3. If the I/N ratio is greater than 3, the period of ignition delay of the petroleum-based aviation fuel may be extended. That is to say, the petroleum-based aviation fuel may be difficult to be ignited. If the I/N ratio is lower than 2, the petroleum-based aviation fuel may exhibit poor cold flow properties, which means that the fluidity of the petroleum-based aviation fuel is not good at low temperature, and a turbid phenomenon may even occur therein. As a result, in order to meet the aviation fuel specifications following blending with the petroleum-based aviation fuel, the sustainable aviation fuel is to have a hydrocarbon composition which has the highest proportion of C8 to C14 hydrocarbons and the I/N ratio ranging from 2 to 3.

Moreover, the petroleum-based aviation fuel that meets the requirements of the aviation fuel specifications is to possess a high flash point so as to be burned at low temperature, and accordingly, the American Society for Testing and Materials (ASTM) stipulates that the flash point of the petroleum-based aviation fuel utilized in the aircraft engines is to be above 38° C. In compliance with the stipulation after being blended with the petroleum-based aviation fuel, the sustainable aviation fuel is to have a flash point not lower than 38° C.

Additionally, the derived cetane number (DCN) is an index for evaluating the spontaneous combustion tendency of the petroleum-based aviation fuel. If the derived cetane number is greater, it indicates that the petroleum-based aviation fuel has a higher tendency to spontaneously ignite. In other words, the period of ignition delay of the petroleum-based aviation fuel may be shortened. Accordingly, the derived cetane number may also be used to evaluate the spontaneous combustion tendency of the sustainable aviation fuel.

### SUMMARY

Therefore, an object of the disclosure is to provide a method for manufacturing a sustainable aviation fuel, which can alleviate at least one of the drawbacks of the prior art. The method includes:
(a) subjecting a feedstock containing an oil to a first reaction with hydrogen in the presence of a first catalyst so that the oil is hydrogenated to saturation and deoxygenated, thereby obtaining a first product containing hydrocarbons, the first reaction being carried out at a temperature ranging from 385° C. to 415° C.; and
(b) subjecting the first product to a second reaction with hydrogen in the presence of a second catalyst so that the hydrocarbons in the first product are cracked and isomerized, thereby obtaining the sustainable aviation fuel, the second catalyst including a silicoaluminophosphate-11 (SAPO-11) carrier loaded with nickel and citric acid, the nickel being present in an amount ranging from 12 wt % to 30 wt % based on 100 wt % of the second catalyst.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to,” and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The disclosure provides a method for manufacturing a sustainable aviation fuel, which includes:
(a) subjecting a feedstock containing an oil to a first reaction with hydrogen in the presence of a first catalyst so that the oil is hydrogenated to saturation and deoxygenated, thereby obtaining a first product containing hydrocarbons, the first reaction being carried out at a temperature ranging from 385° C. to 415° C.; and
(b) subjecting the first product to a second reaction with hydrogen in the presence of a second catalyst so that the hydrocarbons in the first product are cracked and isomerized, thereby obtaining the sustainable aviation fuel, the second catalyst including a silicoaluminophosphate-11 (SAPO-11) carrier loaded with nickel and citric acid, the nickel being present in an amount ranging from 12 wt % to 30 wt % based on 100 wt % of the second catalyst.

According to the present disclosure, the type and source of the feedstock are not limited as long as the feedstock contains one kind of oil.

According to the present disclosure, the first catalyst is used to catalyze the first reaction involving the feedstock and the hydrogen. Any catalyst that may hydrosaturate and deoxygenate the oil of the feedstock is suitable for serving as the first catalyst. In certain embodiments, the first catalyst may include an alumina carrier loaded with the nickel. For the purpose of advancing the first reaction between the feedstock and the hydrogen, in certain embodiments, the nickel may be present in an amount ranging from 5 wt % to 15 wt % based on 100 wt % of the first catalyst.

According to the present disclosure, the hydrocarbons of the first product may be categorized into a linear hydrocarbon and a non-linear hydrocarbon based on the molecular structure. The linear hydrocarbon may include a linear alkane, and the non-linear hydrocarbon may include a branched alkane, a cycloalkane, and an aromatic hydrocarbon. In addition, the hydrocarbons of the first product may be categorized into a C1-C7 hydrocarbon, a C8-C16 hydrocarbon, and a C17-C20 hydrocarbon based on the carbon number.

According to the present disclosure, in order to allow the C8-C16 hydrocarbon to have the highest content among the hydrocarbons in the first product, the temperature of the first reaction in step (a) is to be controlled within a range from 385° C. to 415° C., and then by adjusting the content of the nickel in the second catalyst (i.e., ranging from 2 wt % to 30 wt % based on 100 wt % of the second catalyst) in step (b), the sustainable aviation fuel thus obtained has the highest content of C8-C14 hydrocarbons, a weight ratio of the non-linear hydrocarbon (i.e., iso-alkanes) to the linear hydrocarbon (i.e., normal alkanes) in decimal form (hereinafter abbreviated as “I/N ratio”) ranges from 2 to 3, and a flash point is not lower than 38° C. The aforementioned properties are similar to those of petroleum-based aviation fuels.

According to the present disclosure, the second catalyst is used to catalyze the second reaction involving the first product and the hydrogen, and includes the SAPO-11 carrier loaded with the nickel and the citric acid. For effectively catalyzing the second reaction between the first product and the hydrogen, in certain embodiments, the nickel may be present in an amount ranging from 12 wt % to 30 wt % based on 100 wt % of the second catalyst. With such amount arrangement accompanied by the design of the temperature range, the sustainable aviation fuel thus manufactured possesses the hydrocarbon composition as well as the properties similar to those of the petroleum-based aviation fuels. In addition to the nickel in the second catalyst having catalytic activity, the SAPO-11 carrier itself also has catalytic activity, and therefore, if the nickel carried by the SAPO-11 carrier has an amount greater than 30 wt % based on 100 wt % of the second catalyst, a surface of the SAPO-11 carrier may be covered by an excess of the nickel and hence the surface of the SAPO-11 that may be exposed is reduced, so that the catalytic activity of the second catalyst is likely to lose, thereby leading to a lack of catalyst endurance thereof. In certain embodiments, a molar ratio of the nickel to the citric acid of the second catalyst ranges from 14:1 to 12:1.

According to the present disclosure, the sustainable aviation fuel manufactured from the method may include a linear hydrocarbon and a non-linear hydrocarbon. The linear hydrocarbon may include a linear C8-C14 hydrocarbon and a linear C15-C18 hydrocarbon. The non-linear hydrocarbon may include a non-linear C8-C14 hydrocarbon and a non-linear C15-C18 hydrocarbon. By limiting the temperature of the first reaction in step (a) to be within the range from 385° C. to 415° C. and by arranging the amount of the nickel to be ranging from 12 wt % to 30 wt % based on 100 wt % of the second catalyst in step (b), the sustainable aviation fuel thus obtained has the highest content of C8-C14 hydrocarbons, and a ratio of the non-linear hydrocarbon (i.e., iso-alkanes) to the linear hydrocarbon (i.e., normal alkanes) in decimal form (hereinafter abbreviated as “I/N ratio”) falls within a range from 2 to 3. The aforementioned properties nearly resemble those of the petroleum-based aviation fuels, which means that hydrocarbon composition and properties of the sustainable aviation fuel may be similar to those of the petroleum-based aviation fuels.

According to the present disclosure, the temperature of the second reaction is not limited as long as being capable of cracking and isomerizing the hydrocarbons in the first product. In certain embodiments, the temperature of the second reaction may range from 370° C. to 390° C., for instance, but is not limited thereto.

The disclosure will be further described by way of the following examples. However, it should be understood that the following examples are solely intended for the purpose of illustration and should not be construed as limiting the disclosure in practice.

### EXAMPLES

### Preparative Example

### A. Preparation of First Catalyst

10.11 g of nickel nitrate hexahydrate was dissolved in 200 mL of ethanol, and then 8 g of alumina carrier was added thereto, followed by stirring at 60° C. for 2 hours, thereby obtaining a first pretreat product. Subsequently, the first pretreat product was subjected to a drying treatment at 200° C. for 9 hours, and then to a calcination treatment in air at 700° C. for 5 hours, thereby obtaining a first crude catalyst. After that, the first crude catalyst was activated for 2 hours in a first tubular reactor that was self-made and under a condition of 600° C. with a hydrogen flow rate of 1000 mL/min, thereby obtaining a first catalyst which was filled in the first tubular reactor. The first catalyst thus obtained included the alumina carrier loaded with the nickel, and the nickel was present in an amount of 10 wt % based on 100 wt % of the first catalyst.

B. Preparation of silicoaluminophosphate-11 (SAPO-11) Carrier

104.21 g of aluminum isopropoxide was dissolved in 202.5 g of deionized water, followed by dropwise adding 57.65 g of phosphoric acid thereto and simultaneously stirring at 25° C. for 2 hours, thereby obtaining a first mixing liquid. Next, 38.25 g of dipropylamine and 0.39 g of dodecyltrimethylammonium bromide were well mixed so as to obtain a second mixing liquid. Afterward, 4.58 g of hexadecylamine and 112.38 g of 1-hexanol were mixed and stirred for 2 hours so as to obtain a third mixing liquid. Subsequently, the second mixing liquid was dropwise added to the first mixing liquid, followed by stirring for 2 hours, and then the third mixing liquid and 7.65 g of silicon dioxide were added thereto, followed by stirring for 2 hours, thereby obtaining a SAPO-11 mixing liquid. After that, the SAPO-11 mixing liquid was subjected to a drying treatment at 180° C. for 24 hours so as to obtain a dried SAPO-11 product. The dried SAPO-11 product was washed alternately with deionized water and ethanol for 2 to 3 cycles, and then was subjected to a drying treatment at 180° C. for 9 hours, followed by a calcination treatment in air at 500° C. for 5 hours, thereby obtaining a SAPO-11 carrier. A molar ratio of alumina, phosphorus pentoxide, and silicon dioxide in the SAPO-11 carrier was 1:1:0.5.

### C. Preparation of Second Catalyst Containing 30 wt % of Nickel and Citric Acid

66.4 g of nickel nitrate hexahydrate was dissolved in 225 ml of ethanol, and then 44 g of the SAPO-11 carrier obtained in section B of this example and 16.8 g of citric acid were added thereto, followed by stirring at 60° C. for 2 hours, thereby obtaining a second pretreat product. The second pretreat product was then subjected to a drying treatment at 200° C. for 9 hours, followed by a calcination treatment in air at 500° C. for 5 hours, thereby obtaining a second crude catalyst. Afterward, the second crude catalyst was activated for 2 hours in a second tubular reactor that was self-made and under a condition of 500° C. with a hydrogen flow rate of 500 mL/min, thereby obtaining a second catalyst which was filled in the second tubular reactor. The second catalyst thus obtained included the SAPO-11 carrier loaded with the nickel and the citric acid. The nickel was present in an amount of 30 wt % based on 100 wt % of the second catalyst, and a molar ratio of the nickel to the citric acid in the second catalyst was 13:1.

### D. Preparation of Second Catalyst Containing 10 wt % of Nickel and Citric Acid

20.22 g of nickel nitrate hexahydrate was dissolved in 225 ml of ethanol, and then 36 g of the SAPO-11 carrier obtained in section B of this example and 65.47 g of citric acid were added thereto, followed by stirring at 60° C. for 2 hours, thereby obtaining a second pretreat product. The second pretreat product was then subjected to a drying treatment at 200° C. for 9 hours, followed by a calcination treatment in air at 500° C. for 5 hours, thereby obtaining a second crude catalyst. Afterward, the second crude catalyst was activated for 2 hours in the second tubular reactor and under a condition of 500° C. with a hydrogen flow rate of 500 mL/min, thereby obtaining a second catalyst which was filled in the second tubular reactor. The second catalyst thus obtained included the SAPO-11 carrier loaded with the nickel and the citric acid. The nickel was present in an amount of 10 wt % based on 100 wt % of the second catalyst, and a molar ratio of the nickel to the citric acid in the second catalyst was 1:5.

### Example 1 (E1)

The sustainable aviation fuel of the present disclosure was prepared as follows.
In step (a), a feedstock (i.e., palm oil) having a flow rate of 1 mL/min was subjected to a first reaction with hydrogen in the first tubular reactor filled with 20 g of the first catalyst obtained in Section A of Preparative Example, thereby obtaining a first product that contains hydrocarbons. The first reaction was carried out at 400° C. and 50 bar pressure, and a volume ratio of the hydrogen to the feedstock was 1000:1.
In step (b), the first product having a flow rate of 0.5 mL/min was subjected to a second reaction with hydrogen in the second tubular reactor filled with 30 g of the second catalyst obtained in Section C of Preparative Example, thereby obtaining a sustainable aviation fuel. The second reaction was carried out at 380° C. and 50 bar pressure, and a volume ratio of the hydrogen to the first product was 1250:1. In addition, the residence time of the first product in the second tubular reactor was 1 h⁻¹.

### Comparative Example 1 (CE1)

The procedures for preparing the sustainable aviation fuel in this example were similar to those in E1, except that the temperature of the first reaction in step (a) was 380° C., and the second catalyst obtained in Section D of Preparative Example was used to replace the second catalyst obtained in Section C of Preparative Example as used in E1. In addition, due to the reduction of the amount of the nickel used while still maintaining the residence time of the first product in the second tubular reactor, i.e., 1h-1, the amount of the second catalyst utilized was correspondingly increased to 40 g.

### <Property Evaluation>

### <Calculation of Amount of Nickel in First Catalyst>

The amount of the nickel in the first catalyst in each of E1 and CE1 was calculated using the following Equation (1):

$$A = B / ( B + C ) \times 100 \% \qquad ( 1 )$$

where
   A=amount of nickel in first catalyst (wt %)
   B=weight of nickel
   C=weight of alumina carrier

In the Equation (1) above, the weight of the nickel (i.e., “B”) could further be calculated using the following Equation (2):

$$B = ( D / E ) \times F \times G \qquad ( 2 )$$

where
   D=atomic weight of nickel
   E=molecular weight of nickel nitrate hexahydrate
   F=concentration of nickel nitrate hexahydrate (i.e., 98%)
   G=weight of nickel nitrate hexahydrate

The results are shown in Table 1 below.

### <Analysis of Composition of First Product: From the Viewpoint of Molecular Structure>

The first product of the respective one of E1 and CE1 was placed in a gas chromatography-flame ionization detector (Shimadzu; Model: GC-FID-QP2010) equipped with an HT-5 column (Scientific Glass Engineering; size: 30 m×0.25 mm×0.1 μm), and was subjected to content analysis regarding linear hydrocarbons, non-linear hydrocarbons and other components based on 100 wt % of the first product.

The results are shown in Table 1 below.

### <Analysis of Composition of First Product: From the Viewpoint of Carbon Number>

The first product of the respective one of E1 and CE1 was placed in the abovementioned gas chromatography-flame ionization detector, and was subjected to content analysis regarding C1-C7 hydrocarbons, C8-C16 hydrocarbons, and C17-C20 hydrocarbons based on 100 wt % of hydrocarbons in the first product.

The results are shown in Table 1 below.

### <Calculation of Amount of Nickel in Second Catalyst>

The amount of the nickel in the second catalyst in each of E1 and CE1 was calculated using the following Equation (3):

$$H = I / ( I + J ) \times 100 \% \qquad ( 3 )$$

where
   H=amount of nickel in second catalyst (wt %)
   I=weight of nickel
   J=weight of SAPO-11 carrier

In the Equation (3) above, the weight of the nickel (i.e., “I”) could further be calculated using the following Equation (4):

$$I = ( K / L ) \times M \times N \qquad ( 4 )$$

where
   K=atomic weight of nickel
   L=molecular weight of nickel nitrate hexahydrate
   M=concentration of nickel nitrate hexahydrate (i.e., 98%)
   N=weight of nickel nitrate hexahydrate

The results are shown in Table 1 below.

### <Analysis of Composition of Sustainable Aviation Fuel>

The sustainable aviation fuel of the respective one of E1 and CE1 was placed in the abovementioned gas chromatography-flame ionization detector, and was subjected to content analysis regarding linear hydrocarbons and non-linear hydrocarbons based on 100 wt % of hydrocarbons in the sustainable aviation fuel.

The results are shown in Table 1 below.

### <Determination of Derived Cetane Number of Sustainable Aviation Fuel>

The sustainable aviation fuel of the respective one of E1 and CE1 was placed in a combustion chamber having a volume of 500 mL, and was subjected to determination of derived cetane number (DCN) using technology well known to those skilled in the art. In addition, each of a civil fuel (Jet-A1) and a military fuel (JP-5) was also subjected to the same determination.

The results are shown in Table 2 below.

### <Determination of Flash Point of Sustainable Aviation Fuel>

The sustainable aviation fuel of the respective one of E1 and CE1 was placed in a Pensky-Martens flash point tester (Normalab; Model: NPM 131), and was subjected to determination of flash point thereof using technology well known to those skilled in the art. In addition, each of the foregoing civil fuel and the foregoing military fuel was also subjected to the same determination.

The results are shown in Table 2 below.

TABLE 1

| | |
|---|---|
| E1 | CE1 |

Step (a)

| First | Temperature (° C.) | | | | 400 | 380 |
|---|---|---|---|---|---|---|
| reaction | | | | | | |
| Feedstock | Flow rate (mL/min) | | | | 1 | 1 |
| | Type | | | | Palm oil | Palm oil |
| First | Amount (g) | | | | 20 | 20 |
| catalyst | Composition | | | | Alumina | Alumina |
| | | | | | carrier | carrier |
| | | | | | and | and |
| | | | | | nickel | nickel |
| | Amount of alumina carrier (wt %) | | | | 100 | 100 |
| | Amount of nickel (wt %) | | | | 10 | 10 |
| First | Hydrocarbons | Linear | Linear | Amount | 89.96 | 91.27 |
| product | | hydrocarbon | alkane | (wt %) | | |
| (molecular | | Non-linear | Branched | Amount | 0.99 | 0.34 |
| structure) | | hydrocarbon | alkane | (wt %) | | |
| | | | Cycloalkane | Amount | 2.72 | 2.30 |
| | | | | (wt %) | | |
| | | | Aromatic | Amount | 5.93 | 0.51 |
| | | | hydrocarbon | (wt %) | | |
| | Other components | | | Amount | 0.40 | 5.58 |
| | | | | (wt %) | | |
| | Total amount of first product (100 wt %) | | | | 100 | 100 |
| First | Hydrocarbons | C1-C7 hydrocarbons | | Amount | 3.17 | 0.10 |
| product | | | | (wt %) | | |
| (carbon | | C8-C16 hydrocarbons | | Amount | 71.76 | 25.95 |
| number) | | | | (wt %) | | |

| | | | |
|---|---|---|---|
| C17-C20 hydrocarbons | Amount | 25.07 | 73.95 |

(wt %)

| | | |
|---|---|---|
| Total amount of hydrocarbons (100 wt %) | 100 | 100 |

Step (b)

| Second | Temperature (° C.) | | | | 380 | 380 |
|---|---|---|---|---|---|---|
| reaction | | | | | | |
| First | Flow rate (mL/min) | | | | 0.5 | 0.5 |
| product | | | | | | |
| Second | Amount (g) | | | | 30 | 40 |
| catalyst | Composition | | | | SAPO-11 | SAPO-11 |
| | | | | | carrier, | carrier, |
| | | | | | nickel, | nickel, |
| | | | | | and | and |
| | | | | | citric | citric |
| | | | | | acid | acid |
| | Amount of SAPO-11 carrier (wt %) | | | | 100 | 100 |
| | Amount of nickel (wt %) | | | | 30 | 10 |
| Sustainable | Hydrocarbons | Linear | Linear C8-C14 | Amount | 21.58 | 8.00 |
| aviation | | hydrocarbon | hydrocarbons | (wt %) | | |
| fuel | | | Linear C15-C18 | Amount | 7.32 | 6.00 |
| | | | hydrocarbons | (wt %) | | |
| | | Non-linear | Non-linear C8-C14 | Amount | 66.59 | 52.00 |
| | | hydrocarbon | hydrocarbons | (wt %) | | |
| | | | Non-linear C15-C18 | Amount | 4.51 | 34.00 |
| | | | hydrocarbons | (wt %) | | |

| | | |
|---|---|---|
| Total amount of hydrocarbons (100 wt %) | 100 | 100 |
| Amount of C8-C14 hydrocarbons (wt %) | 88.17 | 60.00 |

| | | |
|---|---|---|
| Ratio of non-linear hydrocarbon to linear hydrocarbon (in | 2.46 | 6.14 |
| decimal form) (i.e., I/N ratio) | | |

TABLE 2

| | | | Petroleum-based | |
|---|---|---|---|---|
| | Sustainable | | aviation fuel | |
| | aviation fuel | | Civil fuel | Military fuel |
| | E1 | CE1 | Jet-A1 | JP-5 |
| Derived cetane | 53.2 | 55.9 | 45.4 | 37.1 |
| number (DCN) | | | | |
| *Flash point (° C.) | 54 | 56 | 38 | 60 |
| Ratio of non- | 2.46 | 6.14 | 2 to 3 | 2 to 3 |
| linear | | | | |
| hydrocarbon to | | | | |
| linear | | | | |
| hydrocarbon (in | | | | |
| decimal form) | | | | |
| (i.e., I/N ratio) | | | | |

*The requirement for flash point is according to the American Society for Testing and Materials (ASTM) D7566 “Standard Specification for Aviation Turbine Fuel Containing Synthesized Hydrocarbons” (2011), which is stipulated to be not lower than (≥) 38° C.

Referring to Table 1, in step (a) of E1, by adopting the temperature of the first reaction to be at 400° C., the first product thus produced has the highest content of C8-C16 hydrocarbons (71.76 wt %), and by having the amount of the nickel carried by the second catalyst to be not greater than 30 wt %, the sustainable aviation fuel thus manufactured attains the highest content of C8-C14 hydrocarbons (88.17%) and the ratio of non-linear hydrocarbon to linear hydrocarbon (i.e., I/N ratio) can fall within the range from 2 to 3 (in decimal form), which indicates that the sustainable aviation fuel in E1 has a similar hydrocarbon composition to the hydrocarbon composition of a petroleum-based aviation fuel.

On the contrary, in step (a) of CE1, the temperature adopted in the first reaction is 380° C. so that the content of C8-C16 hydrocarbons in the first product is not high enough (25.95 wt %). In addition, the amount of the nickel carried by the second catalyst is only 10 wt %, and consequently, the I/N ratio determined in the sustainable aviation fuel thus manufactured cannot fall within the range of 2 to 3 (in decimal form) even though the content of C8-C14 hydrocarbons thereof is already high enough (60.00 wt %), which indicates that the sustainable aviation fuel in CE1 does not have a similar hydrocarbon composition to the hydrocarbon composition of the petroleum-based aviation fuel.

Referring to Table 2, the derived cetane number (DCN) determined in the sustainable aviation fuel of E1 is better than the DCN determined in each of the civil fuel and the military fuel. Moreover, the flash point determined in the sustainable aviation fuel of E1 is 54° C., which is better than the flash point of the civil fuel, and the I/N ratio determined in the sustainable aviation fuel of E1 is in the same range (i.e, 2 to 3) as the I/N ratio determined in each of the civil fuel and the military fuel. However, the I/N ratio determined in the sustainable aviation fuel of CE1 (i.e., 6.14) does not fall within the same range (i.e., 2 to 3) as the I/N ratio determined in each of the civil fuel and the military fuel. The aforesaid results demonstrated that the sustainable aviation fuel of E1 has similar or even superior properties to the properties of the petroleum-based aviation fuel while the sustainable aviation fuel of CE1 does not possess such properties as those of the petroleum-based aviation fuel.

In summary, by limiting the temperature of the first reaction in step (a) of the method of the present disclosure to be within the range from 385° C. to 415° C. and the content of the nickel in step (b) of the method of the present disclosure to be within the range from 12 wt % to 30 wt % based on 100 wt % of the second catalyst, the hydrogen composition and the properties of the sustainable aviation fuel thus manufactured may be similar to the hydrogen composition and the properties of the petroleum-based aviation fuel, thereby meeting the requirement of the American Society for Testing and Materials (ASTM) so that the sustainable aviation fuel obtained from the method of the present disclosure may be used solely in a combustion chamber of an aircraft engine or be used in combination of the petroleum-based aviation fuel for aviation applications.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIGURE, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for producing a sustainable aviation fuel, comprising:
(a) subjecting a feedstock containing an oil to a first reaction with hydrogen in the presence of a first catalyst so that the oil is hydrogenated to saturation and deoxygenated, thereby obtaining a first product containing hydrocarbons, the first reaction being carried out at a temperature ranging from 385° C. to 415° C.; and
(b) subjecting the first product to a second reaction with hydrogen in the presence of a second catalyst so that the hydrocarbons in the first product are cracked and isomerized, thereby obtaining the sustainable aviation fuel, the second catalyst including a silicoaluminophosphate-11 (SAPO-11) carrier loaded with nickel and citric acid, the nickel being present in an amount ranging from 12 wt % to 30 wt % based on 100 wt % of the second catalyst.

2. The method as claimed in claim 1, wherein the first catalyst includes an alumina carrier loaded with nickel, the nickel being present in an amount ranging from 5 wt % to 15 wt % based on 100 wt % of the first catalyst.

3. The method as claimed in claim 1, wherein the hydrocarbons of the first product includes a linear hydrocarbon and a non-linear hydrocarbon, the linear hydrocarbon including a linear alkane, the non-linear hydrocarbon including a branched alkane, a cycloalkane, and an aromatic hydrocarbon.

4. The method as claimed in claim 1, wherein the hydrocarbons of the first product includes a C1-C7 hydrocarbon, a C8-C16 hydrocarbon, and a C17-C20 hydrocarbon.

5. The method as claimed in claim 1, wherein a molar ratio of the nickel to the citric acid of the second catalyst ranges from 14:1 to 12:1.

6. The method as claimed in claim 1, wherein the sustainable aviation fuel contains a linear hydrocarbon and a non-linear hydrocarbon.

7. The method as claimed in claim 6, wherein a weight ratio of the non-linear hydrocarbon to the linear hydrocarbon in decimal form ranges from 2 to 3.
